(19) United States
(12) Patent Application Publication
(10) Pub. No.: US 2026/0069986 A1
(43) Pub. Date: Mar. 12, 2026

(54) ACCESS MANAGEMENT TO A COMPUTER GAME

(71) Applicant: FENNICA GAMING OY, Helsinki (FI)

(72) Inventor: Kimmo KOSKINEN, Espoo (FI)

(21) Appl. No.: 18/882,150

(22) Filed: Sep. 11, 2024

(51) Int. Cl. A63F 13/73

(52) U.S. Cl. CPC A63F 13/73

(57) ABSTRACT

A computer-implemented method for managing access to a gaming session is provided, the method comprises: monitoring a receipt of a number of access requests to the gaming session; determining a parameter from a received access request among the number of access requests; comparing the parameter to a respective parameter; and setting a detection result to express one of the following: i) an access to the gaming session is allowed based on the received access request, ii) an access to the gaming session is rejected based on the received access request. Also a server, a computer program and a multiplayer computer game system are disclosed.

### TECHNICAL FIELD

The invention concerns in general the technical field of computer games. More particularly, the invention concerns an access management to the computer games.

### BACKGROUND

The development of a computing power and communication technologies has enabled an execution of computer-implemented multiplayer games between a plurality of players in a manner that closely resembles a face-to-face gaming session between the players. However, one challenge in the computer-implemented multiplayer games is to gather the plurality of players in the gaming session at the same time in order to provide the shared user experience in an appropriate way. Because this has turned out to be difficult there is developed solutions in which the players are playing the games asynchronously. An example of such an approach is described in a patent document US 2016/0260290 A1 in which a solution for facilitating an asynchronous group play of an online casino game is disclosed.

The asynchronous multiplayer games are also, partly due to their nature, subject to misconduct and one form of misconduct is that the users, i.e. the players, collude with each other with an aim to improve a winning probability. One form of collusion may e.g. that the players share information with each other in a situation that a first player has not been successful, such as not gained any win, in the gaming session, but another player tries to enter to the same gaming session with information received from the first player.

Hence, there is a need to introduce solutions that at least in part prevent the above described situations.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a server, a computer program and a multiplayer computer game system for managing access to a gaming session among a plurality of gaming sessions.

The objects of the invention are reached by a method, a server, a computer program and a multiplayer computer game system for managing access to a gaming session among a plurality of gaming sessions as defined by the respective independent claims.

According to a first aspect, a computer-implemented method for managing access to a gaming session among a plurality of gaming sessions in a computer game wherein the gaming session is user selectable is provide, the method comprises:
monitoring, in response to a detection that a result of a game played by a user in the gaming session corresponds to a reference value, a receipt of a number of access requests to the gaming session,
determining a parameter from a received access request among the number of access requests,
comparing the parameter to a respective parameter related to the user whose result of the game played in the gaming session corresponds to the reference value, and
setting, in accordance with a comparison between the parameter from at least one received access request and the respective parameter related to the user whose result of the game played in the gaming session corresponds to the reference value, a detection result to express one of the following: i) an access to the gaming session is allowed based on the received access request, ii) an access to the gaming session is rejected based on the received access request.

The parameter may be data at least representing a network address of a terminal device.

Alternatively or in addition, the parameter may be data at least representing an identifier of the terminal device.

Alternatively or in addition, the parameter may be data at least representing user credentials generated for a user to access the gaming session.

Alternatively or in addition, the parameter may be data at least representing a position of the terminal device.

Alternatively or in addition, the parameter may be data representing one or more events occurred to the user in the gaming session.

Moreover, the comparison may be performed by determining a dependency between users with respect to the one or more events occurred in the gaming session.

The method may further comprise:
blocking the user to access the computer game in response to the detection result expressing that the access to the gaming session is rejected based on the received access request.

The method may further comprise:
allocating the user to another gaming session among the plurality of the gaming sessions to that requested by the user.

According to a second aspect, a server for managing access to a gaming session among a plurality of gaming sessions in a computer game wherein the gaming session is user selectable is provided, the server is configured to:
monitor, in response to a detection that a result of a game played by a user in the gaming session corresponds to a reference value, a receipt of a number of access requests to the gaming session,
determine a parameter from a received access request among the number of access requests,
compare the parameter to a respective parameter related to the user whose result of the game played in the gaming session corresponds to the reference value, and
set, in accordance with a comparison between the parameter from at least one received access request and the respective parameter related to the user whose result of the game played in the gaming session corresponds to the reference value, a detection result to express one of the following: i) an access to the gaming session is allowed based on the received access request, ii) an access to the gaming session is rejected based on the received access request.

The server may be configured to apply data, as the parameter, representing at least a network address of a terminal device.

Alternatively or in addition, the server may be configured to apply data, as the parameter, representing at least an identifier of the terminal device.

Alternatively or in addition, the server may be configured to apply data, as the parameter, representing at least user credentials generated for a user to access the gaming session.

Alternatively or in addition, the server may be configured to apply data, as the parameter, representing at least a position of the terminal device.

Alternatively or in addition, the server may be configured to apply data, as the parameter, representing one or more events occurred to the user in the gaming session.

Moreover, the server may be configured to perform the comparison by determining a dependency between users with respect to the one or more events occurred in the gaming session.

The server may further be configured to:
block the user to access the computer game in response to the detection result expressing that the access to the gaming session is rejected based on the received access request.

The server may further be configured to:
allocate the user to another gaming session among the plurality of the gaming sessions to that requested by the user.

According to a third aspect, a computer program product is provided, the computer program comprising at least one non-transitory computer-readable storage medium having computer-executable program code instructions stored therein, the program code instructions being configured when the computer program product is executed on a computer, to cause the computer to at least:
monitor, in response to a detection that a result of a game played by a user in the gaming session corresponds to a reference value, a receipt of a number of access requests to the gaming session,
determine a parameter from a received access request among the number of access requests,
compare the parameter to a respective parameter related to the user whose result of the game played in the gaming session corresponds to the reference value, and
set, in accordance with a comparison between the parameter from at least one received access request and the respective parameter related to the user whose result of the game played in the gaming session corresponds to the reference value, a detection result to express one of the following: i) an access to the gaming session is allowed based on the received access request, ii) an access to the gaming session is rejected based on the received access request.

According to a fourth aspect, a multiplayer computer game system is provided, the multiplayer computer game system comprising:
a plurality of terminal devices for accessing to a gaming session among a plurality of gaming sessions, and
a server for managing access to a gaming session among a plurality of gaming sessions in a computer game wherein the gaming session is user selectable, the server is configured to:
   monitor, in response to a detection that a result of a game played by a user in the gaming session corresponds to a reference value, a receipt of a number of access requests to the gaming session,
   determine a parameter from a received access request among the number of access requests,
   compare the parameter to a respective parameter related to the user whose result of the game played in the gaming session corresponds to the reference value, and
   set, in accordance with a comparison between the parameter from at least one received access request and the respective parameter related to the user whose result of the game played in the gaming session corresponds to the reference value, a detection result to express one of the following: i) an access to the gaming session is allowed based on the received access request, ii) an access to the gaming session is rejected based on the received access request.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an asynchronous multiplayer computer game system according to an example.

FIG. 2 illustrates schematically an asynchronous multiplayer computer game system according to another example.

FIG. 3 illustrates schematically a gaming server according to an example.

FIG. 4 illustrates schematically a method according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

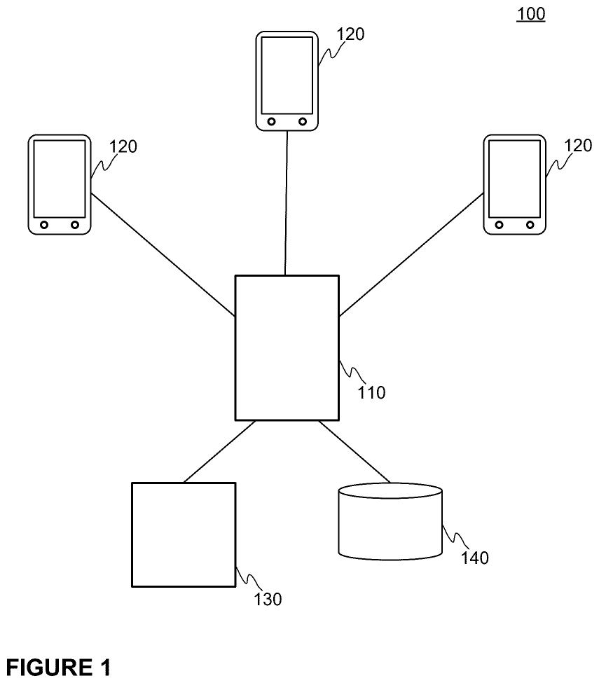

FIG. 1 illustrates schematically an example embodiment of an asynchronous multiplayer computer game system 100. In accordance with the example embodiment the system 100 comprises a server 110 configured to execute operations causing an execution of one or more computer games, such as gambling games, in the server 110. The execution of the computer game in the server 110 at least refers to a hosting of a number of terminal devices 120 in an asynchronous manner in order to enable users, i.e. players, of the terminal devices 120 to participate to the computer game. An access to participate to the asynchronous multiplayer computer game hosted by the server 110 may be established to the terminal devices 120 over a communication network, such as Internet. The communication connections between communicating entities may be established by applying wireless or wired communication technologies, or any combination of these. In addition to the above described operations the server 110 may be configured to perform further operations with respect to the execution of the asynchronous multiplayer computer game in the server 110, such as determining a result of a gaming session e.g. through a lottery operation.

In some example embodiments the system 100 may be implemented so that the server 110 is arranged to execute the asynchronous multiplayer computer game, but another server 130, e.g. called as a lottery generator server, may be arranged to execute an engine for generating lottery items applied in the asynchronous multiplayer computer game for determining rankings between the players. The engine may be configured to generate random values which are then applied in the determination of the rankings between the players. The lottery generator server 130 may then generate one or more data arrays e.g. determining a result of the respective game. The application of the items generated by the lottery generator server 130 is dependent on the type of the computer game, naturally.

In accordance with some example embodiments the system 100 may further comprise one or more data storages 140 e.g. implementing a database into which the server 110 may store various type of data related to the asynchronous multiplayer computer game. The data storage 140 may also be configured to store user profiles of the players if such are enabled to be created and maintained in the data storage. The user profiles may also comprise data defining a monetary value for a number of the players available to be used in a context of the asynchronous multiplayer computer game. Still further, the one or more data storages 140 may also serve other servers, such as the lottery generator server 130, by allowing storing of data.

The term ‘terminal device’ 120 shall be understood in a broad manner and covering any device enabling a participation to the gaming session. This may require a communication capability of the terminal devices 120 with the server 110 but also a capability to receive an input from a user as well as a capability to output data to the user, i.e. to the player. The execution of the computer game in the terminal device 120 may require an installation of an application in the terminal device 120, for example. The terminal device may, for example, include laptop computers, handheld computers, personal computers, phones, gaming devices, game consoles, and so on.

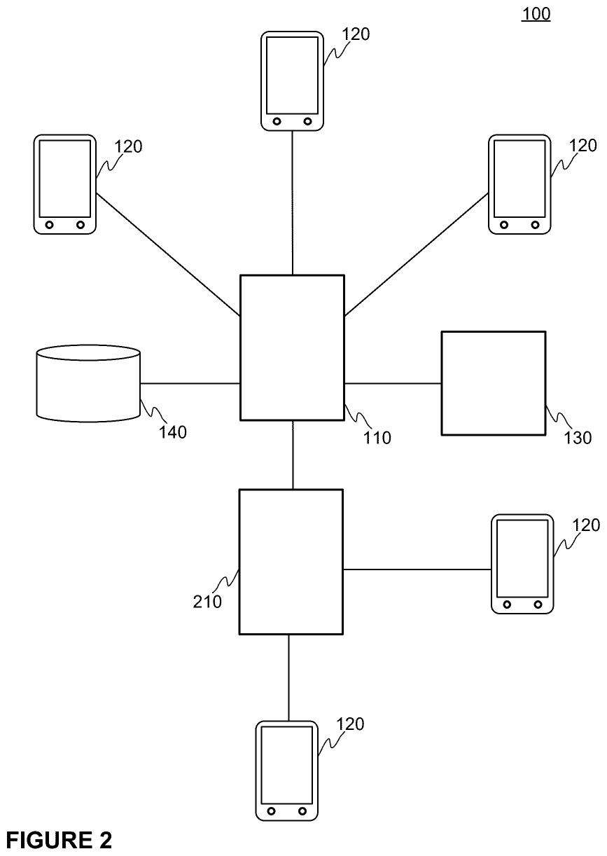

Furthermore, in some example embodiments the system 100 as shown in FIG. 1 may comprise an implementation in which at least some of the terminal devices 120 participating to the gaming session are connectable to the gaming server 110 over another server 210 hosting at least some of the terminal devices 120 as shown in FIG. 2. Such a server 210 may e.g. reside in a casino house into which a number of terminal devices 120 are arranged to play the asynchronous multiplayer computer game.

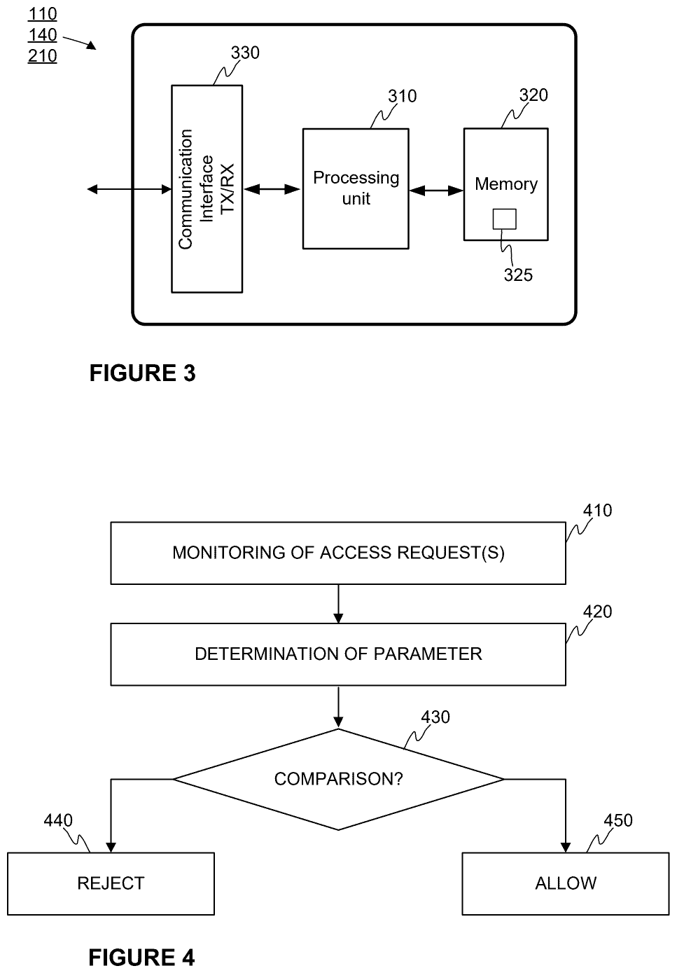

An example of the server 110, i.e. the gaming server, is schematically illustrated in FIG. 3. The apparatus implanting functionalities of the server 110 may be a computer device, for example. In other words, the apparatus of FIG. 3 may be configured to perform operations as is described in the forthcoming description. For sake of clarity, it is worthwhile to mention that the block diagram of FIG. 3 depicts some components of an entity that may be employed to implement a functionality of the apparatus.

The apparatus of FIG. 3 comprises a processor 310 and a memory 320. The memory 320 may store data, but also computer program code 325 causing a management of the asynchronous multiplayer computer game in a manner as is described in the forthcoming description. The apparatus may further comprise a communication interface 330, such as a wireless communication interface or a communication interface for wired communication, or both to communicate with other entities. The communication interface 330 may thus comprise one or more modems, antennas, and any other hardware and software for enabling an execution of the communication e.g. under control of the processor 310. Furthermore, I/O (input/output) components may be arranged, together with the processor 310 and a portion of the computer program code 325, to provide a user interface for receiving input from a user and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 320 and at least a portion of the computer program code 325 stored therein may further be arranged, with the processor 310, to cause the apparatus to perform at least a portion of a method as is described in the forthcoming description. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some, or all of which may be integrated/removable and/or may provide permanent/semi-permanent/dynamic/cached storage.

The computer program code 325 may comprise computer-executable instructions that implement functions that correspond to steps implemented in the method when loaded into the processor 310 of the respective server 110. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform a method as described. Hence, the apparatus may comprise at least one processor 310 and at least one memory 320 including the computer program code 325 for one or more programs, the at least one memory 320 and the computer program code 325 configured to, with the at least one processor 310, cause the apparatus implementing the server 110 to perform the method.

The computer program code 325 may be provided e.g. a computer program product comprising at least one computer-readable non-transitory medium having the computer program code 325 stored thereon, which computer program code 325, when executed by the processor 310, causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the other servers 130 and 210 may resemble the structure of the server 110 as shown in FIG. 3. Naturally, at least the computer program code 325 executed in the other servers differ from the one executed in the gaming server 110.

The operation of the server 110, as well as the other servers 130, 210, may be implemented with a plurality of apparatuses, such as with the one schematically illustrated in FIG. 3, as a distributed computing environment. The distributed computing environment may be implemented as a cloud computing system wherein a number of apparatuses are harnessed to execute operations to generate an implementation of a method as is described herein.

Next at least some aspects of the invention are described by referring to FIG. 4 schematically illustrating a method for managing access to a gaming session. The access management of the gaming session, i.e. the execution of the method, may be performed by the gaming server 110 or the responsibility may be assigned to another computing device into which the users, i.e. the players, connect with their terminal devices 120 when they are willing to access the gaming session. In the forthcoming description it is however assumed that the method is performed in the gaming server 110 even though the invention is not limited only to such an implementation. Hence, the access management relates to an access to a computer game executed in a gaming session wherein the computer game refers to an asynchronous multiplayer computer game, such as a computer-implemented gambling game into which players participate with their terminal devices 120. The computer game may advantageously be by nature such that a reward is given to one or more players in accordance with their success in the game and the reward motivates the players to be successful in the game.

The method of access management may advantageously be executed continuously when the gaming session is active and the functionality may serve a plurality of gaming sessions so that each gaming session is seen as an own entirety. The functionality may store data in data storage 140 and access the data. For example, the data may be arranged in a database and made inquirable therefrom. The data maintained in the data storage e.g. as data records comprises information on users participating and/or participated in the gaming session as well as information descriptive of one or more events occurred in the game per each user. As a non-limiting example the information descriptive of the number of events may comprise a result of the game per each user but also other data, such as information on network address from which the users connect to the gaming server, position information of the terminal device, data descriptive on events occurred and/or occurring during the gaming session e.g. due to users selections, etc.

Hence, the access management functionality is implemented so that access requests received to access the gaming session are monitored 410 at least in response to a detection that a result of a game played by a user in the gaming session corresponds to a reference value. This refers to that first it is detected that a user, i.e. a player, has participated in a gaming session and a play of the game generates a result of the game with respect to the user in question wherein the result is compared to a reference value. For example, the result of the game may be a value that indicates that the user won in the game or that the user lost in the game, and thus in the gaming session, and the reference value may correspond to a value indicative of at least one of these, such as a value representing the loss in the game. Thus, if it is detected that the user in question received a result in the game corresponding to the reference value, cf. e.g. the loss in the game, any access requests received thereafter are monitored 410.

As a result, the gaming server 110 may start receiving a number of access requests to the gaming session in question after the result of the game of a user corresponds to the reference value. The gaming server 110 is configured to determine 420 a parameter from a received access request among the number of access requests. Moreover, the gaming server 110 is configured to compare 430 the parameter to a respective parameter with respect to the user whose result of the game played in the gaming session corresponds to the reference value, i.e. the user who already has played the game. Thus, in the comparison 430 the aim is to find a link between information related to the user whose result corresponds to the reference value and a user behind an access request received by the gaming server 110 wherein the link may refer to a result of comparison that the values of the compared parameters correspond to each, e.g. are the same. Based on a value of the parameter and the comparison it is possible to make a decision with respect to the received access request, i.e. if the user behind the access request is to be allowed 450 in the gaming session or if the access is to be rejected 440. Thus, a detection result may be set to express either that the access to the gaming session is allowed to the user behind the new access request or to express that the access to the gaming session is rejected. In the first situation the user may be accessed to the gaming session and this may e.g. be informed to the terminal device 120 of the respective user with an applicable message. In the second situation the access to the gaming session is denied and a message to the terminal device 120 of the user may generated.

The parameter in the access request which is determined and used in the comparison 430 may be anything based on which it may be performed an evaluation if the user already having the result of the game and another user behind the new access request are linked together, and, thus, colluded with each other. In accordance with an embodiment of the invention the parameter is data representing at least a part of network addresses, such as an IP addresses, of the terminal devices 120, connected to the gaming server 110. In this kind of approach the aim is to determine if the terminal device 120 of the user having a result of the game corresponding to the reference value and a terminal device 120 of a further access request have the same network address at a predefined accuracy which may be interpreted that the users are locating geographically in the same place, i.e. they are connecting to the gaming server 120 through the same routing device, for example. In such a situation the user trying to access to the gaming session later may be interpreted to have received information in relation to the game and the gaming session from the user already having the result of the game and, in that manner, benefit from the information so as to succeed in the game in a better way. This is considered unallowable and the access to the gaming session may be rejected 440, i.e. a detection result of the comparison may be set accordingly.

In accordance with another embodiment of the invention the parameter may be data representing an identifier of the terminal device 120 that is carried in the access request. As a non-limiting example of the identifier of the terminal device 120 an IMEI (International Mobile Equipment Identity) code may be mentioned. Hence, gaming server 110 may be arranged to compare 430 as parameters if the identity of the terminal device 120 of a user having a result in the game corresponding to the reference value to an identity of terminal device(s) 120 derivable from any further access requests received and monitored by the gaming server 110. In case it turns out that a further access request is received from the same terminal device 120, the gaming server 110 is configured to classify that as an attempt of a collusion due to that another user may use the terminal device 120 of the user having the result of her/his game corresponding to the reference value. This is because it may be assumed that two users reside in the same location, i.e. close to the terminal device 120 used in both access attempts to the gaming session of the asynchronous multiplayer computer game. In other words, the access to the gaming session is rejected 440 by setting the detection result accordingly. On the other hand, if no such a detection with respect to the terminal devices 120 is not made, the access may be allowed 450 by setting the detection result accordingly.

In accordance with a further embodiment the parameter may refer to data representing user credentials, i.e. the user identifier, used in accessing the gaming session. In other words, the access to the gaming session, and, thus, to the game, may require an input of user credentials and in accordance with the embodiment the user credentials may be used as the parameter based on which the comparison 430 and decision-making may be performed. In other words, if a user with certain credentials has played the game with a result corresponding to a reference value, it may be arranged that an access to the gaming session is prevented with the same user credentials. The prevention may be made dependent on a predefined criteria, wherein the criteria may e.g. be time, i.e. the prevention may be made valid over a predefined period of time brought out as a non-limiting example. In some embodiments, in addition to the credentials an identifier of the terminal device 120 used in the generation of the access request to access the gaming session may be evaluated within the parameter in the step denoted with 420 if such information is arranged to be carried in the access request. Then, it may be arranged that if the user credentials represent a user already played the game with the result correspond to the reference value but the identifier of the terminal device 120 differs from the identifier of the terminal device 120 used in the gaming session that generated the result, it may be concluded that another user generated the access request, but received the credentials from the user already played the game and, thus, it may be concluded that a collusion attempt is going on. As a result, the access to the gaming session may be rejected 440. The example provided herein makes it clear that the term parameter shall be understood as data that may comprise one or more values representing various aspects in relation to users, such as identities, identities of terminal devices, etc., in any manner. In case there area multiple values representing various aspects embedded in the parameter, the reference value is also defined accordingly to make it comparable with the parameter delivered in the access request.

According to a still further embodiment the parameter may comprise data representing a position information carried in the access request alone or in addition to any other parameter data as described. The position information may refer to any data from which a position of the terminal device 120 the user is using in the generation of the access request is derivable. For example, the position information may refer to geographical coordinates obtainable from any positioning system applicable by the terminal device 120. The position information of the users is applied in the same manner as described in the foregoing description with respect to other parameter data.

In still some further embodiments even more sophisticated approaches may be introduced wherein the parameter is data being descriptive, i.e. representing, on one or more events occurred to the users in the gaming session. In such an approach one or more values descriptive on the one or more events occurred to the users are generated on the users whose result is known. The same is performed to any latter user who are allowed to enter the gaming session in the beginning. Herein, the decision-making may be performed by comparing 430 the parameters of the respective users so that any dependencies between the parameters, i.e. the events occurred for each user, are determined. The dependencies may be expressed as game related patterns, i.e. if there are certain events occurred to the first user and if another user takes actions leading to certain other actions, e.g. continuously, the dependency may be determined and a collusion may be determined to be found. As a result of this, the access of the latter user may be rejected, i.e. she/he cannot continue the participation in the gaming session and the user is removed therefrom. The same may be performed on the basis of an analysis of the dependency of a history data of the two players e.g. in a response to a receipt of the access request from the latter user. The analysis to determine a number of dependencies based on the parameters established in the described manner may be performed with a computer program coded to implement a rule-based analysis or with a machine-learning model trained to perform the dependency analysis as described.

In the description herein it is provided that one outcome of the method to manage access to the gaming session may be that the user is rejected 440 to access to the gaming session. As a consequence of this various approaches to manage the user may be introduced in accordance with the invention. In accordance with a first embodiment the user behind the access request in question may be prevented to play the computer game. The prevention may be defined to be time-dependent, i.e. the access to the computer game is denied with respect to the user over a predefined period of time. The period of time may be defined to be hours, days, or even longer time windows, even permanent. Such an action may be achieved by storing information about the user to a register arranged to store information on denied users and the record of the user may also define the period of time, she/he is blocked to access to the computer game. The data in the data record may be read every time a new access request is received and one or more operations to block the user may be performed in response information on the user is found from the register storing the record. In accordance with another embodiment the approach with respect to a user rejected to access the gaming session in question may be such that the user is allocated to another gaming session of the same computer game. As there may be available a plurality of concurrent gaming sessions accessible to users only the gaming session rejected for the user may be blocked and at least one other gaming session may be made accessible to the user in question. Naturally, the procedure according to the method is advantageously performed with respect to the user and the allocated, or selected, gaming session so as to confirm that the user is allowed to access the new gaming session. In response to a detection of the allowance to access the user is taken to the other gaming session than originally requested. In some embodiments, the user may be informed that she/he is to be allocated to another gaming session and a confirmation to accept this may be requested. Moreover, if the allocation of the other gaming session is performed by the gaming server 110, the allocation procedure may comprise a computer-implemented step in which the information with respect to the user in terms of the applied parameters used in the evaluation of the access right are checked with respect to other users being in the gaming session into which the user in question is planned to be allocated. In case no issues arise in the evaluation, the user is allocated to the gaming session in question. On other hand, if any concerns arise in the evaluation, an allocation of the user to a further gaming session is evaluated. The latter approach as described has an advantage that it results a positive outcome from the user point of view, i.e. an access to a gaming session, especially in situations that a collusion detection based on the method has generated a faulty detection. Such faulty detections may occur because the criteria to generate the detections are based on predefined rules which may, in some improbable situations, generate detection without a reason.

The invention and its various embodiments describe a solution for preventing, or at least mitigating a possibility to, a collusion between users willing to play a computer game in a gaming session. Such an approach is especially important in computer games in which players are rewarded in accordance with a result of the game, such as in gambling games.

The specific examples provided in the description given above should not be construed as limiting the applicability and/or the interpretation of the appended claims. Lists and groups of examples provided in the description given above are not exhaustive unless otherwise explicitly stated.

1. A computer-implemented method for managing access to a gaming session among a plurality of gaming sessions in a computer game, wherein the gaming session is user selectable, the method comprising:
monitoring, in response to detecting that a result of a game played in the gaming session corresponds to a reference value and identifying a reference user associated with the game whose result corresponds to the reference value, a receipt of a number of access requests to the gaming session, each of the number of access requests having an associated said user and at least one parameter, each said at least one parameter having an associated value,
selecting one of said at least one parameter from a received access request among the number of access requests,
comparing the value for the selected parameter associated with the received access request to the value of the selected parameter associated with the reference user, and
setting a detection result based on the comparing, wherein the detection result is one of:
i) access to the gaming session is allowed based on the received access request, and
ii) access to the gaming session is rejected based on the received access request.

2. The method according to claim 1, wherein the selected parameter is a network address of a terminal device.

3. The method according to claim 1, wherein the selected parameter is an identifier of the terminal device.

4. The method according to claim 1, wherein the selected parameter is user credentials generated for a said user to access the gaming session.

5. The method according to claim 3, wherein the selected parameter is a position of the terminal device.

6. The method according to claim 1, wherein the selected parameter identifies one or more events that occurred for the user in the gaming session.

7. The method according to claim 6, wherein the comparison is performed by determining a dependency between two of the users with respect to the one or more events occurred in the gaming session.

8. The method according to claim 1, the method further comprising:
blocking access of the user associated with received access request to the computer game in response to the detection result, and generating a message expressing that the access to the gaming session is rejected based on the received access request.

9. The method according to claim 1, the method further comprising:
allocating the user associated with the received access request to a said gaming session among the plurality of the gaming sessions different from the gaming session requested by the user associated with the received access request.

10. A server for managing access to a gaming session among a plurality of gaming sessions in a computer game wherein the gaming session is user selectable, wherein the server is configured to:
monitor, in response to detecting that a result of a game played in the gaming session corresponds to a reference value and identifying a reference user associated with the game whose result corresponds to the reference value, a receipt of a number of access requests to the gaming session, each of the number of access requests having an associated said user and at least one parameter, each said at least one parameter having an associated value,
select one of said at least one parameter from a received access request among the number of access requests,
compare the value for the selected parameter associated with the received access request to the value of the selected parameter associated with the reference user, and
set a detection result based on the comparison, wherein the detection result is one of:
i) access to the gaming session is allowed based on the received access request, and
ii) access to the gaming session is rejected based on the received access request.

11. The server according to claim 10, wherein the selected parameter is a network address of a terminal device.

12. The server according to claim 10, wherein the selected parameter is an identifier of the terminal device.

13. The server according to claim 10, wherein the selected parameter is user credentials generated for a said user to access the gaming session.

14. The server according to claim 10, wherein the selected parameter is a position of the terminal device.

15. The server according to claim 10, wherein the selected parameter identifies one or more events occurred to the user in the gaming session.

16. The server according to claim 15, wherein the server is configured to perform the comparison by determining a dependency between two of the users with respect to the one or more events occurred in the gaming session.

17. The server according to claim 10, wherein the server is further configured to:
block access of the user associated with the received access request to the computer game in response to the detection result, and generate a message expressing that the access to the gaming session is rejected based on the received access request.

18. The server according to claim 1, wherein the server further configured to:
allocate the user associated with the received access request to a said gaming session among the plurality of the gaming sessions different from the gaming session requested by the user associated with the received access request.

19. A non-transitory computer-readable storage medium having computer-executable program code instructions stored therein that, when executed on a computer, cause the computer to at least:
monitor, in response to detecting that a result of a game played in the gaming session corresponds to a reference value and identifying a reference user associated with the game whose result corresponds to the reference value, a receipt of a number of access requests to the gaming session, each said received access request having an associated said user and at least one parameter, each said at least one parameter having an associated value,
select one of said at least one parameter from a received access request among the number of access requests,
compare the value associated with the selected parameter associated with the received access request to the value of the selected parameter associated with the reference user, and
set a detection result based on the comparison, wherein the detection result is one of:
i) access to the gaming session is allowed based on the received access request, and
ii) access to the gaming session is rejected based on the received access request.

20. A multiplayer computer game system comprising:
a plurality of terminal devices configured for accessing to a gaming session among a plurality of gaming sessions, and
a server for managing access to a gaming session among a plurality of gaming sessions in a computer game wherein the gaming session is user selectable, the server is configured to:
monitor, in response to detecting that a result of a game played in the gaming session corresponds to a reference value and identifying a reference user associated with the game whose result corresponds to the reference value, a receipt of a number of access requests to the gaming session, each said received access request having an associated said user and at least one parameter, each said at least one parameter having an associated value,
select one of said at least one parameter from a received access request among the number of access requests,
compare the value for with the selected parameter associated with the received access requests to the value of the selected parameter associated with the reference user, and
set a detection result based on the comparison, wherein the detection result is one of:
i) access to the gaming session is allowed based on the received access request, and
ii) access to the gaming session is rejected based on the received access request.
